(19) United States
(12) Patent Application Publication
(10) Pub. No.: US 2025/0317583 A1
(43) Pub. Date: Oct. 9, 2025

(54) METHOD AND APPARATUS FOR TRANSMITTING A PLURALITY OF DATA STREAMS, DEVICE, AND MEDIUM

(71) Applicant: Beijing Zitiao Network Technology Co., Ltd., Beijing (CN)

(72) Inventors: Yao ZHANG, Beijing (CN); Jiuling XIAN, Beijing (CN); Jing DU, Beijing (CN); Lei ZHANG, Beijing (CN); Shiyang ZHANG, Beijing (CN)

(21) Appl. No.: 18/872,271

(22) PCT Filed: Aug. 30, 2023
(86) PCT No.: PCT/CN2023/115819

§ 371 Date: Dec. 5, 2024

(30) Foreign Application Priority Data
Sep. 16, 2022 (CN) 202211129092.4

(51) Int. Cl. H04N 19/186; H04N 21/2343

(52) U.S. Cl. CPC H04N 19/186; H04N 21/234363

(57) ABSTRACT

There are provided a method and an apparatus for transmitting a plurality of data streams, a device, and a medium. The method of transmitting a plurality of data streams comprises: obtaining, at a first device, the plurality of data streams to be transmitted. The method further comprises merging the plurality of data streams based on a transmission resolution to generate a merged data stream, the transmission resolution being greater than a sum of resolutions of the plurality of data streams. The method further comprises transmitting the merged data stream to a second device. In this way, the user can transmit the plurality of data streams to another device through only a single link. This reduces the link maintenance cost and improves the reliability of data transmission.

The present application claims priority to Chinese Patent Application No. 202211129092.4, filed on Sep. 16, 2022 and entitled “METHOD AND APPARATUS FOR TRANSMISSION OF A PLURALITY OF DATA STREAMS, DEVICE, AND MEDIUM”, which is incorporated herein by reference in its entirety.

### FIELD

Example embodiments of the present disclosure generally relate to the field of computers, and in particular to a method and an apparatus for transmitting a plurality of data streams, a device, and a computer-readable storage medium.

### BACKGROUND

With the development of Internet technologies, Internet-based services have been used more and more widely and have become an important part of people's daily lives. When using Internet-based services, people need to exchange data between a plurality of devices. For example, when a user needs to use a cloud rendering service, the user needs to upload data to be rendered to a cloud rendering platform, and the cloud rendering platform sends a rendering result to the corresponding user after performing a rendering task. In addition, with the development and expansion of application scenarios of cloud rendering technologies, cloud rendering technologies have been applied to scenarios such as virtual live streamings and virtual meetings. In these scenarios, users need to transmit more and more data. For example, users usually need to transmit a plurality of data streams to a cloud rendering platform.

In other words, with the development of Internet technologies, data exchange between users becomes more frequent and diverse. Therefore, it is necessary to provide an efficient data transmission mechanism to improve transmission efficiency of a plurality of data streams.

### SUMMARY

In a first aspect of the present disclosure, there is provided a method for transmitting a plurality of data streams. The method includes obtaining, at a first device, a plurality of data streams to be transmitted. The method further includes merging the plurality of data streams based on a transmission resolution to generate a merged data stream, the transmission resolution being greater than a sum of resolutions of the plurality of data streams. The method further includes transmitting the merged data stream to a second device.

In a second aspect of the present disclosure, there is provided an apparatus for transmitting a plurality of data streams. The apparatus includes a data stream obtaining module, configured to obtain, at a first device, a plurality of data streams to be transmitted. The apparatus further includes a merging module, configured to merge the plurality of data streams based on a transmission resolution to generate a merged data stream, the transmission resolution being greater than a sum of resolutions of the plurality of data streams. The apparatus further includes a transmission module, configured to transmit the merged data stream to a second device.

In a third aspect of the present disclosure, there is provided an electronic device. The device includes at least one processing unit; and at least one memory; the at least one memory being coupled to the at least one processing unit and storing instructions executable by the at least one processing unit. The instructions, when executed by the at least one processing unit, cause the device to perform the method of the first aspect.

In a fourth aspect of the present disclosure, there is provided a computer-readable storage medium. A computer program is stored on the medium, and the computer program is executed by a processor to implement the method of the first aspect.

It should be appreciated that the content described in the Summary section is not intended to limit key or important features of the embodiments of the present disclosure, nor is it intended to limit the scope of the present disclosure. Other features of the present disclosure will be readily understood through the following description.

### BRIEF DESCRIPTION OF THE DRAWINGS

The above and other features, advantages, and aspects of embodiments of the present disclosure will become more apparent with reference to the following detailed description in conjunction with the accompanying drawings. In the drawings, the same or similar reference numerals denote the same or similar elements, where:

FIG. 1 shows a schematic diagram of an example environment in which embodiments of the present disclosure may be applied;

FIG. 2 shows a flowchart of a process of processing an offline rendering task according to some embodiments of the present disclosure;

FIG. 3 shows a schematic diagram of another example environment in which embodiments of the present disclosure may be applied;

FIG. 4 shows a block diagram of an apparatus for processing an offline rendering task according to some embodiments of the present disclosure; and

FIG. 5 shows a block diagram of a device capable of implementing a plurality of embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for illustrative purposes, and are not intended to limit the scope of protection of the present disclosure.

In the description of the embodiments of the present disclosure, the term “include/comprise” and similar terms should be understood as open inclusion, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below.

It can be understood that the data involved in the technical solutions of the present disclosure (including but not limited to the data itself, the obtaining or use of the data) should comply with the requirements of corresponding laws, regulations, and relevant provisions.

It can be understood that before using the technical solutions disclosed in the embodiments of the present disclosure, the user should be informed of the type, scope of use, and usage scenarios of the personal information involved in the present disclosure in an appropriate manner and obtain the user's authorization in accordance with relevant laws and regulations.

For example, when receiving an active request from a user, a prompt message is sent to the user to clearly prompt the user that the operation requested by the user will need to obtain and use the user's personal information. Therefore, the user can choose whether to provide personal information to the software or hardware such as the electronic device, the application, the server, or the storage medium that executes the operation of the technical solution of the present disclosure according to the prompt information.

As an optional but non-limiting implementation, in response to receiving an active request from a user, the prompt message is sent to the user, for example, in the form of a pop-up window, and the prompt message can be presented in the pop-up window in text. In addition, the pop-up window may also carry a select control for the user to select “Agree” or “Disagree” to provide personal information to the electronic device.

It can be understood that the above notification and obtaining the user's authorization process are only schematic and do not limit the implementation of the present disclosure. Other methods that meet relevant laws and regulations may also be applied to the implementation of the present disclosure.

As described above, with the development of Internet technologies, data exchange between devices becomes more frequent and diverse. For example, users usually need to exchange a plurality of data streams with other devices. In the conventional transmission solutions of a plurality of data streams, when a user needs to transmit a plurality of data streams, the user needs to establish a plurality of additional links to transmit the plurality of data streams, and maintaining the plurality of links brings an additional link maintenance cost to the user. In addition, data synchronization between the plurality of links also requires additional processing and communication overheads. More importantly, when one link in the plurality of links fails to transmit, the entire data transmission will be retransmitted, thereby ultimately affecting the user experience. Therefore, it is necessary to provide an efficient data transmission mechanism to improve transmission efficiency of a plurality of data streams.

According to some embodiments of the present disclosure, a transmission solution of a plurality of data streams is provided. According to the solution of the present disclosure, when a user needs to exchange a plurality of data streams, the user merges the plurality of data streams based on a transmission resolution to generate a merged data stream, where the transmission resolution is greater than a sum of resolutions of the plurality of data streams.

In this way, the user only needs to establish and maintain one link to transmit the plurality of data streams to another device. This reduces the link maintenance cost of the user and improves reliability of data transmission.

### EXAMPLE ENVIRONMENT

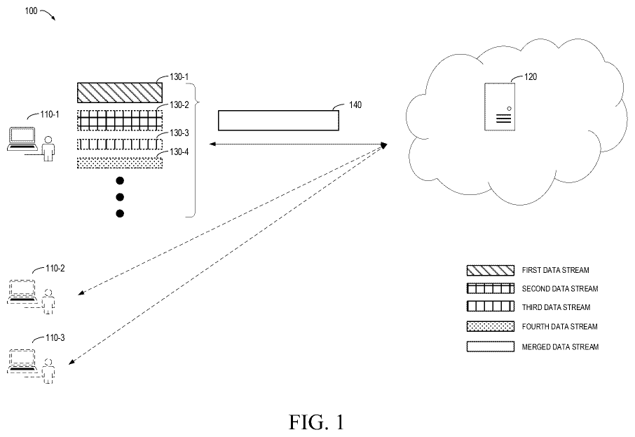

FIG. 1 shows a schematic diagram of an example environment 100 in which embodiments of the present disclosure can be implemented. The environment 100 includes first devices 110-1, 110-2, and 110-3 and a second device 120. For case of discussion, the first devices 110-1, 110-2, and 110-3 may be collectively or individually referred to as the first device 110. The environment 100 further includes the second device 120, and the first device 110 and the second device 120 may communicate through a wired or wireless manner.

Further, in the feature embodiment of FIG. 1, the first device 110-1 needs to transmit a data stream to the second device 120. As shown in FIG. 1, the first device 110-1 needs to transmit a data stream 130-1, and optionally data streams 130-2, 130-3, and 130-4, to the second device 120. For case of discussion, the first data stream 130-1, the second data stream 130-2, the third data stream 130-3, and the fourth data stream 130-4 may be collectively referred to as the data stream 130, or may be individually referred to as the first data stream 130-1, the second data stream 130-2, the third data stream 130-3, and the fourth data stream 130-4.

In some embodiments, the first device 110-1 may merge the plurality of data streams 130 based on a transmission resolution to generate a merged data stream 140, where the transmission resolution is greater than a sum of resolutions of the plurality of data streams 130 to be transmitted. Further, the merged data stream 140 may be transmitted to the second device 120 in the form of a single data stream.

In some embodiments, different data streams 130 may have different resolutions. For example only, the first data stream 130-1 and the second data stream 130-2 may have a first resolution, for example, 1080P; and the third data stream 130-3 and the fourth data stream 130-4 may have a second resolution, for example, 720P.

Further, different data streams 130 may have different color encoding formats. For example only, the first data stream 130-1 and the third data stream 130-3 may have a first color encoding format, for example, an RGBA format; and the second data stream 130-2 and the fourth data stream 130-4 may have another color encoding format, for example, including only transparency information, such as alpha channel data.

Further, different data streams 130 may be independent of or associated with each other. For example only, the first data stream 130-1 may be associated with the second data stream 130-2. In a specific embodiment, the second data stream 130-2 is obtained by cropping the first data stream 130-1. In another specific embodiment, the second data stream 130-2 is associated with transparency information of the first data stream 130-1. For example, the first data stream 130-1 is data in an RGBA format, and the second data stream 130-2 is associated with alpha channel data of the first data stream 130-1.

It should be appreciated that the above examples of the data stream 130 are for illustrative purposes only and should not be construed as any limitation to the present disclosure. In other embodiments, the resolution, association, color encoding format, and other characteristics of the data stream 130 may vary according to a specific application scenario. The various embodiments of the present disclosure are not limited in this regard.

In some embodiments, the first device 110 may be implemented as a terminal device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/handheld video camera, a positioning device, a TV receiver, a radio broadcast receiver, an e-book device, a gaming device, or any combination thereof, including accessories and peripherals of these devices, or any combination thereof. In some embodiments, the terminal device can also support any type of interface for users, such as a “wearable” circuit.

In some embodiments, the second device 120 is a device that provides a rendering service, and in particular, may be a cloud rendering device.

In some embodiments, the first device 110 transmits the plurality of data streams 130 to the second device 120 through an application such as a browser or a client. The second device 120 receives the plurality of data streams 130 and performs a corresponding rendering task. Subsequently, a rendering result may be returned to the first user device 110 or another corresponding device.

In some embodiments, a user may run applications such as virtual live streaming or virtual meeting on the first device 110. In these specific application scenarios, the user may deploy at least one image capturing device, such as a camera unit, at the first device 110 to capture audio/video image data of the user. Further, in these specific application scenarios, in addition to the main screen display, there will be other virtual screens to display additional video streams or image information. In addition, the user may also have requirements such as a virtual or rendered background. For example, the user expects to change the background to a specific scene, such as a specific meeting room or starry sky. In this case, the user usually needs to transmit one or more of the following data to the second device 120; audio/video image data captured by the image capturing device, image data or algorithm data for a rendering operation, alpha channel data, and data of other customed types. These data are respectively included in the plurality of different data streams 130. In some embodiments, the plurality of data streams 130 are merged into the merged data stream 140 and transmitted to the second device 120 for rendering.

It should be appreciated that the above specific scenarios are only used to illustrate the scenarios of a plurality of data stream transmission, and should not be understood as a limitation on the application scenarios of the present disclosure. In other words, in other embodiments, the first device 120 and the second device 120 may be other types of devices, and the first device 120 and the second device 120 may also run other applications. The various embodiments of the present disclosure are not limited in this regard.

It should be appreciated that FIG. 1 shows only an example environment of a plurality of data stream transmission. In other words, the number and association of the first device 110, the second device 120, the data streams 130, and the merged data stream 140 shown in FIG. 1 are merely illustrative and schematic. In other embodiments, the environment 100 may include more or fewer first devices 110, second devices 120, data streams 130, and merged data streams 140, and the association may also vary according to a specific application scenario. The various embodiments of the present disclosure are not limited in this regard.

### EXAMPLE METHOD

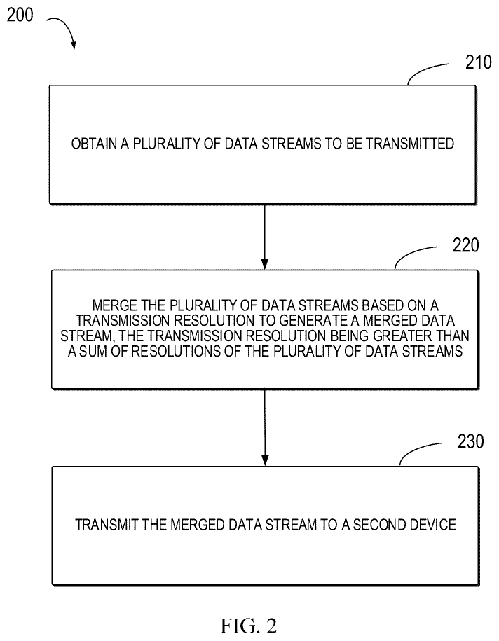

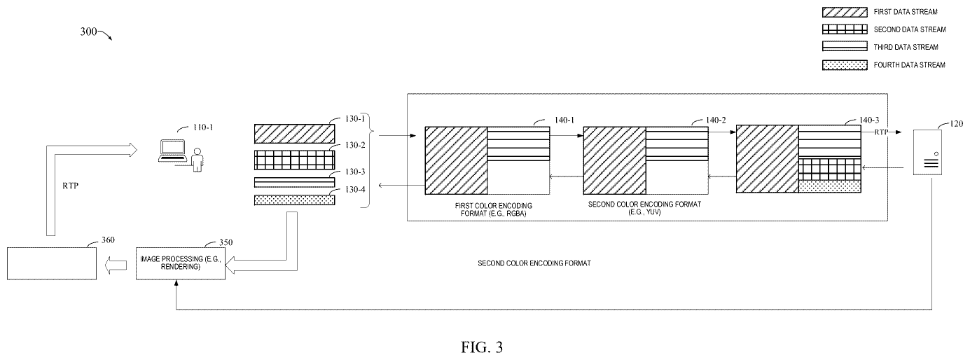

FIG. 2 shows a flowchart of a process 200 of implementing transmission of a plurality of data streams according to some embodiments of the present disclosure. FIG. 3 shows a schematic diagram of another example environment 300 in which embodiments of the present disclosure can be applied. In some embodiments, the process 200 may be implemented at the first device 110, such as the first device 110-1.

For case of discussion, the process 200 will be discussed with reference to the environment 100 of FIG. 1 and the environment 300 of FIG. 3. It should be understood that although the method of the process 200 is discussed with reference to the environment 100 of FIG. 1 and the environment 300 of FIG. 3, as the present disclosure has discussed, the environment 100 and the environment 300 are only example environments of the present disclosure, and therefore the environment 100 and the environment 300 should not be understood as a limitation on the implementation environment of the process 200.

Further, for case of understanding, in some embodiments, the data streams 130-1 to 130-4 will be used as examples of a plurality of data streams, RGBA will be used as an example of the first color encoding format, YUV will be used as an example of the second color encoding format, and alpha channel information will be used as an example of transparency information. It should be appreciated that the above specific examples are for illustrative purposes only and should not be construed as a limitation to the present disclosure. For example, in other embodiments, the number of data streams 130 may vary, and the color encoding format of the data stream 130 may also use any existing or future-defined color encoding format, and the transparency information is represented as other color characteristic parameters. The various embodiments of the present disclosure are not limited in this regard.

In some embodiments, the color encoding format RGBA has four channel data, that is, red (R), green (G), blue (B), and an alpha channel; the color encoding format YUV has three channel data, that is, luminance/grayscale (Y), chroma (U), and saturation (Y); and the alpha channel data is considered as single-channel data.

Further, the present disclosure is also not limited in terms of the device types of the first device 110 and the second device 120. For example, in some embodiments, the first device 110 is a terminal device, and the second device 120 is a server device. Alternatively, in other embodiments, both the first device 110 and the second device 120 are terminal devices.

In addition, the process 200 may be applicable to any application scenarios that require exchange of a plurality of data streams. One example scenario is virtual live streaming. Another example application scenario is virtual meeting. Yet another example application scenario is virtual studio. In these example implementation scenarios, the first device 110 may be a virtual live streaming, a virtual studio, or a virtual meeting client, and the second device 120 may be a cloud rendering platform.

At block 210, the first device 110-1 obtains the plurality of data streams 130 to be transmitted. As shown in FIG. 3, the first device 110-1 obtains the data streams 130-1, 130-2, 130-3, and 130-4. In some embodiments, at least one of the plurality of data streams 130 is an image data stream, such as a video data stream.

In some embodiments, the first device 110-1 periodically collects data of the input plurality of data streams 130. In some embodiments, the first device 110-1 determines a timing value according to a set input frame rate, where the timing value may be a reciprocal of the input frame rate. For example, when the input frame rate is configured as 30 frames/second, the timing value is determined as 33 ms. The first device 110-1 periodically collects the plurality of data streams 130 according to the determined timing value.

Further, the first device 110-1 may obtain the data streams 130 in a variety of ways. In a specific embodiment, the data stream 130 is captured by an image capturing device at the first device 110-1. For example, the first device 110-1 is a virtual live streaming or a virtual meeting client, and the first device 110-1 captures local video data through a camera unit to obtain the data stream 130. In another specific embodiment, the data stream 130 may be video data stored at the first device 110-1, for example, video data stored at the first device 110-1 for rendering. It should be appreciated that the embodiments of the present disclosure are not limited in terms of the manner in which the data stream 130 is obtained.

In some embodiments, different data streams 130 may be obtained independently of each other. For example, the first data stream 130-1 is captured by a first camera, and the second data stream 130-2 is a locally stored image file for rendering. Alternatively, in other embodiments, the obtaining manners of different data streams 130 may be associated with each other. For example, the second data stream 130-2 may be obtained by cropping the first data stream 130-1, or the second data stream 130-2 is associated with transparency information of the first data stream 130-1. In a specific embodiment, the first data stream 130-1 is a data stream in an RGBA format, and the second data stream 130-2 is alpha channel data, where the alpha channel data of the second data stream 130-2 may be independent of the first data stream 130-1 or may be associated with alpha channel data of the first data stream 130-1.

In some embodiments, different data streams 130 may have different resolutions. For example only, the first data stream 130-1 and the second data stream 130-2 may have a first resolution, for example, 1080P; and the third data stream 130-3 and the fourth data stream 130-4 may have a second resolution, for example, 720P.

Further, different data streams 130 may have different color encoding formats. For example only, the first data stream 130-1 and the third data stream 130-3 may have a first color encoding format, for example, an RGBA format; and the second data stream 130-2 and the fourth data stream 130-4 may have another color encoding format, for example, including only transparency information, such as alpha channel data.

At block 220, the first device 110-1 merges the plurality of data streams 130 based on a transmission resolution to generate a merged data stream 140, where the transmission resolution is greater than a sum of resolutions of the plurality of data streams to be transmitted. At block 230, the first device 110-1 transmits the merged data stream 140 to the second device 120.

By way of the merging operation based on the transmission resolution, the first device 110-1 only needs to maintain one transmission link, that is, may transmit the plurality of data streams 130 to the second device 120. At the same time, no additional data synchronization processing is required at the sending end and the receiving end. In addition, when data of the plurality of data streams 130 are associated with each other, the receiving end may better recover data, and data retransmission caused by transmission failure of a part of links may be avoided. For a cloud rendering scenario, problems of unexecutable rendering tasks and poor rendering effect caused by transmission failure of some links may be avoided.

Next, the process of merging the plurality of data streams 130 to generate the merged data stream 140 will be discussed in detail with reference to FIG. 3. In addition, to better describe details of the merging operation, in the specific embodiment of FIG. 3, the following assumptions are made for the data streams 130-1 to 130-4; the resolution of the first data stream 130-1 is 1080P, and the encoding format is a first color encoding format, such as an RGBA format; the resolution of the second data stream 130-2 is 1080P, and is associated with transparency information, such as alpha channel data, and the second data stream 130-2 is associated with transparency information of the first data stream 130-1; the resolution of the third data stream 130-3 is 720P, and the encoding format is a first color encoding format, such as an RGBA format; and the resolution of the fourth data stream 130-1 is 720P, and is associated with transparency information, such as alpha channel data, and the fourth data stream 130-2 is not associated with transparency information of the third data stream.

In some embodiments, the first device 110-1 first determines the transmission resolution, and allocates a storage space in a memory according to the transmission resolution, to write the plurality of data streams 130 into the allocated storage space. An example of the storage space may be a volatile memory, including a memory, a register, a cache, and the like. In this way, the merging efficiency of the plurality of data streams 130 will be improved.

In some embodiments, the first device 110-1 may obtain respective resolutions of the plurality of data streams 130, and determine a sum of the resolutions of the plurality of data streams 130. Additionally, in some embodiments, the first device 110-1 may use a sum of the sum of the resolutions of the plurality of data streams 130 and a predetermined or dynamically determined resolution margin as the transmission resolution.

Alternatively, in some embodiments, the first device 110-1 may determine the transmission resolution according to a plurality of parameters. An example of the parameter is a maximum resolution in the respective resolutions of the plurality of data streams 130. Another example of the parameter is the number of the plurality of data streams. In a specific embodiment, the transmission resolution may be a product of the maximum resolution in the respective resolutions of the plurality of data streams 130 and the number of the plurality of data streams 130. In the specific embodiment of FIG. 3, the maximum resolution is 1080P, and the number of the plurality of data streams 130 is 4, so the transmission resolution may be a product of 1080P and 4.

It should be appreciated that the above examples of determining the transmission resolution are merely illustrative. In other embodiments, any appropriate parameters and appropriate rules may be used to determine the transmission resolution, so that the determined transmission resolution can accommodate the plurality of data streams 130. The various embodiments of the present disclosure are not limited in this regard.

In some implementations, a first partial data stream of the plurality of data streams 130 may have a first color encoding format, and a second partial data stream of the plurality of data streams 130 may be associated with transparency information. In the specific embodiment of FIG. 3, the first data stream 130-1 and the third data stream 130-3 have the first color encoding format, and the second data stream 130-3 and the fourth data stream 130-4 are associated with the transparency information.

In some embodiments, the first device 110-1 preferentially merges a data stream having the first color encoding format with other data streams, rather than with a data stream associated with the transparency information. In the specific embodiment of FIG. 3, the first device 110-1 preferentially merges the first data stream 130-1 and the third data stream (140-1).

In some embodiments, for each data stream 130, the first device 110-1 preferentially writes head information, where the head information includes data information of each data stream 130, such as resolution, data format, and additional information length. Image data of each data stream is then written.

In some embodiments, to reduce the amount of data transmitted, an encoding format of some of the plurality of data streams 130 may be converted. Specifically, color encoding format conversion (140-2) is performed on at least one of the plurality of data streams to reduce a number of color encoding channels, and the at least one data stream that has undergone the color encoding format conversion is merged with other data streams (140-3). In the specific embodiment of FIG. 3, the first device 110-1 converts encoding formats of the first data stream 130-1 and the third data stream 130-3, for example, converts an RGBA format into a YUV format, and merges the converted first data stream 130-1 and the third data stream 130-3 with the second data stream 130-2 and the fourth data stream 130-4. In this way, the total amount of data to be transmitted is reduced without sacrificing data quality too much, thereby improving transmission efficiency.

In some embodiments, to simplify the structure of the system, the color encoding format conversion operation may be set as a necessary operation, and the color encoding format operation is only applicable to multi-channel data. In this case, if the color encoding formats of the plurality of data streams 130 are all single-channel formats, the necessary color encoding format operation will lead to data errors. To avoid the above problem, if the color encoding formats of the plurality of data streams 130 are all single-channel formats, the plurality of data streams 130 are first converted into a first group of data streams having a first color encoding format. Next, the first group of data streams is converted into a second group of data streams having a second color encoding format, where both the first color encoding format and the second color encoding format are multi-channel formats, and finally the second group of data streams is merged. In this way, the structure of the system is simplified, and it is possible to process a plurality of types of data streams through only a single system structure.

In the specific embodiment of FIG. 3, if only the second data stream 130-2 and the fourth data stream 130-4 are included, the second data stream 130-2 and the fourth data stream 130-4 may be first converted into an RGBA format to generate a first group of data streams, and the first group of data streams is converted into a YUV format to generate a second group of data streams, and the second group of data streams is merged to generate the merged data stream 140.

In some embodiments, the merged data stream 140 may be transmitted to the second device 120 in a TCP or UDP manner. The various embodiments of the present disclosure are not limited in terms of a specific transmission manner. In some embodiments, the merged data stream 140 is transmitted to the second device 120 in a real-time transport protocol (RTP) manner. In this way, both transmission reliability and transmission efficiency will be improved.

With continued reference to FIG. 3, after the second device 120 receives the merged data stream 140, the second device 120 may restore the merged data stream 140 to the plurality of data streams through an inverse operation of the merging operation. For example, the second device 120 may first extract a data stream associated with transparency information. In the specific embodiment of FIG. 3, after receiving the merged data stream, the second device 120 may first extract the second data stream 130-2 and the fourth data stream 130-4.

In some embodiments, the second device 120 may convert a color encoding format of a data stream into a color encoding format that is easier to process. For example, the second device may perform color encoding format conversion on at least one of the merged data stream 140 to increase a number of color encoding channels. In the specific embodiment of FIG. 3, the second device 120 converts color encoding formats of the first data stream 130-1 and the third data stream 130-1, for example, converts a YUV format into an RGBA format.

In some embodiments, the second device 120 extracts head information corresponding to each data stream 130 for each data stream 130. As mentioned above, the head information may include data information of each data stream 130, such as resolution, data format, additional information length, and the like. In this way, the second device 120 can better perform subsequent processing on the received plurality of data streams 130.

Further, as discussed above, different data streams may be associated with each other. For example, the second data stream 130-2 may be obtained by cropping the first data stream 130-1, or the second data stream 130-2 is associated with transparency information of the first data stream 130-1. In this case, data of the second data stream 130-2 may be used to assist in conversion of the color encoding format of the first data stream 130-1. In the specific embodiment of FIG. 3, the second data stream 130-2 is associated with alpha channel information of the first data stream 130-1. When converting the encoding format of the first data stream 130-1 from YUV to RGBA, reference may be made to data of the second data stream 130-2. In this way, the impact of the color encoding format conversion on the data stream may be minimized.

In some embodiments, the second device 120 may perform subsequent processing (350) on the restored plurality of data streams 130, such as a rendering operation. The processed data may be stored (360) and subsequently transmitted to a corresponding device.

In some embodiments, the processing result may be transmitted to the corresponding device in a TCP or UDP manner. The various embodiments of the present disclosure are not limited in terms of a specific transmission manner. In the specific embodiment of FIG. 3, the processing result is transmitted to the first device 110-1 in a real-time transport protocol manner. In this way, both transmission reliability and transmission efficiency will be improved.

In a specific scenario of virtual live streaming and virtual meeting, one of the plurality of data streams 130 may be a video stream including a user image, and the second device 120 may be a cloud rendering device. In this case, after the plurality of data streams 130 are restored, the second device 120 may perform operations such as cutout on the data stream including the user image to obtain the user image, and fuse the user image with other virtual backgrounds to render and generate a specific virtual live streaming or virtual meeting scenario.

In this way, especially for scenarios such as virtual live streaming and virtual meetings that require collaborative transmission of a plurality of data streams, the plurality of data streams 130 may be processed by merging, color encoding format conversion, and the like, and then transmitted to another device in the form of a single data stream, thereby reducing the link maintenance cost. More importantly, since the first device 110-1 merges the plurality of data streams 130 into a single data stream locally before transmission, the problem of data loss caused by separate transmission of a plurality of data streams within a single frame is avoided, thereby improving reliability of data transmission.

### EXAMPLE APPARATUS AND DEVICE

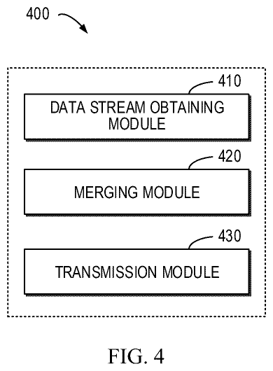

FIG. 4 shows a block diagram of an apparatus 400 for processing an offline rendering task according to some embodiments of the present disclosure. The apparatus 400 may be implemented as or included in the first device 110. Each module/component in the apparatus 400 may be implemented by hardware, software, firmware, or any combination thereof.

As shown, the apparatus 400 includes a data stream obtaining module 410, configured to obtain, at the first device 110, a plurality of data streams to be transmitted. The apparatus 400 further includes a merging module 420, configured to merge the plurality of data streams based on a transmission resolution to generate a merged data stream, the transmission resolution being greater than a sum of resolutions of the plurality of data streams. The apparatus 400 further includes a transmission module 430, configured to transmit the merged data stream to the second device 120.

In some embodiments, the transmission resolution is determined based on a maximum resolution in respective resolutions of the plurality of data streams and a number of the plurality of data streams.

In some embodiments, the plurality of data streams include: a first data stream 130-1, the first data stream 130-1 having a first color encoding format; and a second data stream 130-2, the second data stream 130-2 being associated with transparency information.

In some embodiments, the second data stream 130-2 is obtained by cropping the first data stream 130-1.

Alternatively, in some embodiments, the second data stream 130-2 is associated with transparency information of the first data stream 130-1.

In some embodiments, the merging module 420 is further configured to: preferentially merge the first data stream 130-1 with other data streams rather than with the second data stream 130-2.

In some embodiments, the merging module 420 is further configured to: perform color encoding format conversion on at least one of the plurality of data streams to reduce a number of color encoding channels; and merge the at least one data stream that has undergone the color encoding format conversion with other data streams.

In some embodiments, the merging module 420 is further configured to: if color encoding formats of the plurality of data streams are all single-channel formats, convert the plurality of data streams into a first group of data streams having a first color encoding format; convert the first group of data streams into a second group of data streams having a second color encoding format, both the first color encoding format and the second color encoding format being multi-channel formats; and merge the second group of data streams.

In some embodiments, at least one of the plurality of data streams is an image data stream, or at least one of the plurality of data streams is captured by an image capturing device at the first device 110.

In some embodiments, the first device 110 is a virtual live streaming or a virtual meeting client device, and the second device 120 is a cloud rendering device.

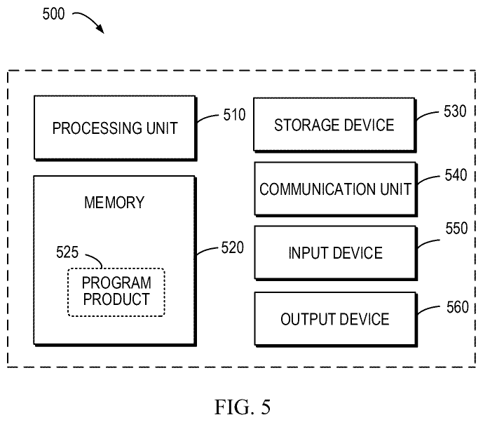

FIG. 5 shows a block diagram of a computing device/system 500 in which one or more embodiments of the present disclosure may be implemented. It should be appreciated that the computing device/system 500 shown in FIG. 5 is merely exemplary, and should not constitute any limitation on the functions and scope of the embodiments described herein. The computing device/system 500 shown in FIG. 5 may be used to implement the first device 110 of FIG. 1.

As shown in FIG. 5, the computing device/system 500 is in the form of a general-purpose computing device. Components of the computing device/system 500 may include, but are not limited to, one or more processors or processing units 510, a memory 520, a storage device 530, one or more communication units 5540, one or more input devices 550, and one or more output devices 560. The processing unit 510 may be a physical or virtual processor and is capable of executing various processes according to programs stored in the memory 520. In a multi-processor system, multiple processing units execute computer-executable instructions in parallel to improve the parallel processing capability of the computing device/system 500.

The computing device/system 500 generally includes a plurality of computer storage media. Such media may be any available media accessible by the computing device/system 500, including but not limited to volatile and non-volatile media, and removable and non-removable media. The memory 520 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 530 may be a removable or non-removable medium, and may include machine-readable media such as a flash drive, a disk, or any other medium that can be used to store information and/or data (for example, training data for training) and can be accessed within the computing device/system 500.

The computing device/system 500 may further include another removable/non-removable, volatile/non-volatile storage medium. Although not shown in FIG. 5, a disk drive for reading from or writing to a removable, non-volatile disk (e.g., a “floppy disk”) and an optical disk drive for reading from or writing to a removable, non-volatile optical disk may be provided. In these cases, each drive may be connected to a bus (not shown) by one or more data medium interfaces. The memory 520 may include a computer program product 525 having one or more program modules configured to perform various methods or actions of various embodiments of the present disclosure.

The communication unit 540 implements communication with other computing devices through a communication medium. Additionally, the functions of the components of the computing device/system 500 may be implemented by a single computing cluster or multiple computing machines that can communicate through a communication connection. Therefore, the computing device/system 500 can operate in a networked environment using a logical connection with one or more other servers, a network personal computer (PC), or another network node.

The input device 550 may be one or more input devices, such as a mouse, a keyboard, a trackball, and the like. The output device 560 may be one or more output devices, such as a display, a speaker, a printer, and the like. The computing device/system 500 may also communicate with one or more external devices (not shown) according to requirements through the communication unit 550, where the external devices are, for example, storage devices, display devices, and the like, communicate with one or more devices that enable a user to interact with the computing device/system 500, or communicate with any device (for example, a network card, a modem, etc.) that enables the computing device/system 500 to communicate with one or more other computing devices. Such communication may be performed via an input/output (I/O) interface (not shown).

According to an exemplary implementation of the present disclosure, there is provided a computer-readable storage medium having stored thereon computer-executable instructions or a computer program, where the computer-executable instructions or the computer program are executed by a processor to implement the method described above.

According to an exemplary implementation of the present disclosure, there is further provided a computer program product that is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices and computer program products implemented according to the present disclosure. It should be appreciated that each block of the flowcharts and/or block diagrams and a combination of the blocks in the flowcharts and/or block diagrams may be implemented by computer-readable program instructions.

These computer-readable program instructions may be provided to a processing unit of a general-purpose computer, a special-purpose computer, or another programmable data processing apparatus to produce a machine, such that the instructions, when executed by the processing unit of the computer or another programmable data processing apparatus, create means for implementing the functions/acts specified in one or more blocks in the flowcharts and/or block diagrams. These computer-readable program instructions may also be stored in a computer-readable storage medium, these instructions enabling a computer, a programmable data processing apparatus, and/or another device to work in a specific manner, so that the computer-readable medium having stored therein the instructions includes an article of manufacture that includes instructions for implementing various aspects of the functions/acts specified in one or more blocks in the flowcharts and/or block diagrams.

The computer-readable program instructions may be loaded onto a computer, another programmable data processing apparatus, or another device, so that a series of operation steps are performed on the computer, another programmable data processing apparatus, or another device to produce a computer-implemented process, such that the instructions executed on the computer, another programmable data processing apparatus, or another device implement the functions/acts specified in one or more blocks in the flowcharts and/or block diagrams.

The flowcharts and block diagrams in the accompanying drawings illustrate the possibly implemented architecture, functions, and operations of the system, method, and computer program product according to a plurality of implementations of the present disclosure. In this regard, each block in the flowchart or block diagram may represent a module, program segment, or part of an instruction, and the module, program segment, or part of the instruction contains one or more executable instructions for implementing the specified logical functions. In some alternative implementations, the functions marked in the blocks may also occur in an order different from that marked in the accompanying drawings. For example, two consecutive blocks may actually be executed substantially in parallel, or they may sometimes be executed in a reverse order, depending on the functions involved. It should also be noted that each block in the block diagram and/or the flowchart, and a combination of the blocks in the block diagram and/or the flowchart may be implemented by a dedicated hardware-based system that executes specified functions or acts, or may be implemented by a combination of dedicated hardware and computer instructions.

The various implementations of the present disclosure have been described above. The foregoing descriptions are exemplary and not exhaustive, and are not limited to the disclosed implementations. Many modifications and changes are obvious to those of ordinary skill in the art without departing from the scope and spirit of the described implementations. The selection of terms used herein is intended to best explain the principles, practical applications, or improvements to the technology in the market of the implementations, or to enable those of ordinary skill in the art to understand the implementations disclosed herein.

1. A method for transmitting a plurality of data streams, comprising:
obtaining, at a first device, a plurality of data streams to be transmitted;
merging the plurality of data streams based on a transmission resolution to generate a merged data stream, the transmission resolution being greater than a sum of resolutions of the plurality of data streams; and
transmitting, to a second device, the merged data stream.

2. The method of claim 1, wherein the transmission resolution is determined based on:
a maximum resolution among respective resolutions of the plurality of data streams; and
a number of the plurality of data streams.

3. The method of claim 1, wherein the plurality of data streams comprise:
a first data stream, the first data stream having a first color encoding format; and
a second data stream, the second data stream being associated with transparency information.

4. The method of claim 3, wherein
the second data stream is obtained by cropping the first data stream, or
the second data stream is associated with transparency information of the first data stream.

5. The method of claim 3, wherein the plurality of data streams comprises:
preferentially merging the first data stream with other data streams as comparative to with the second data stream.

6. The method of claim 1, wherein merging the plurality of data streams comprises:
performing color encoding format conversion on at least one of the plurality of data streams to reduce a number of color encoding channels; and
merging the at least one data stream that has undergone the color encoding format conversion with other data streams.

7. The method of claim 1, wherein merging the plurality of data streams to be transmitted into the merged data stream comprises:
if color encoding formats of the plurality of data streams are all single-channel formats, converting the plurality of data streams into a first group of data streams having a first color encoding format;
converting the first group of data streams into a second group of data streams having a second color encoding format, both the first color encoding format and the second color encoding format being multi-channel formats; and
merging the second group of data streams.

8. The method of claim 1, wherein
at least one of the plurality of data streams is an image data stream, or
at least one of the plurality of data streams is captured by an image capturing device at the first device.

9. The method of claim 1, wherein the first device is a virtual live streaming or a virtual meeting client device, and the second device is a cloud rendering device.

10. (canceled)

11. An electronic device, comprising:
at least one processing unit; and
at least one memory, the at least one memory being coupled to the at least one processing unit and storing instructions executable by the at least one processing unit, the instructions, when executed by the at least one processing unit, causing the device to perform a method for transmitting a plurality of data streams, comprising:
obtaining, at a first device, a plurality of data streams to be transmitted;
merging the plurality of data streams based on a transmission resolution to generate a merged data stream, the transmission resolution being greater than a sum of resolutions of the plurality of data streams; and
transmitting, to a second device, the merged data stream.

12. A non-transitory computer-readable storage medium having stored thereon a computer program, the computer program being executed by a processor to implement a method for transmitting a plurality of data streams, comprising:
obtaining, at a first device, a plurality of data streams to be transmitted;
merging the plurality of data streams based on a transmission resolution to generate a merged data stream, the transmission resolution being greater than a sum of resolutions of the plurality of data streams; and
transmitting to a second device, the merged data stream.

13. The electronic device of claim 11, wherein the transmission resolution is determined based on:
a maximum resolution among respective resolutions of the plurality of data streams; and
a number of the plurality of data streams.

14. The electronic device of claim 11, wherein the plurality of data streams comprise:
a first data stream, the first data stream having a first color encoding format; and
a second data stream, the second data stream being associated with transparency information.

15. The electronic device of claim 14, wherein
the second data stream is obtained by cropping the first data stream, or
the second data stream is associated with transparency information of the first data stream.

16. The electronic device of claim 14, wherein merging the plurality of data streams comprises:
preferentially merging the first data stream with other data streams as comparative to with the second data stream.

17. The electronic device of claim 11, wherein merging the plurality of data streams comprises:
performing color encoding format conversion on at least one of the plurality of data streams to reduce a number of color encoding channels; and
merging the at least one data stream that has undergone the color encoding format conversion with other data streams.

18. The electronic device of claim 11, wherein merging the plurality of data streams to be transmitted into the merged data stream comprises:
if color encoding formats of the plurality of data streams are all single-channel formats, converting the plurality of data streams into a first group of data streams having a first color encoding format;
converting the first group of data streams into a second group of data streams having a second color encoding format, both the first color encoding format and the second color encoding format being multi-channel formats; and
merging the second group of data streams.

19. The electronic device of claim 11, wherein
at least one of the plurality of data streams is an image data stream, or
at least one of the plurality of data streams is captured by an image capturing device at the first device.

20. The method of claim 11, wherein the first device is a virtual live streaming or a virtual meeting client device, and the second device is a cloud rendering device.

21. The non-transitory computer-readable storage medium according to claim 11, wherein the transmission resolution is determined based on:
a maximum resolution among respective resolutions of the plurality of data streams; and
a number of the plurality of data streams.
